(19) United States
(12) Patent Application Publication
(10) Pub. No.: US 2013/0110555 A1
(43) Pub. Date: May 2, 2013

(54) SYSTEMS AND METHODS FOR MANAGING PHARMACY CLAIMS

(71) Applicants: Leslie S. Dunham, Lithia, FL (US); Carol A. Swirsky, Branford, CT (US); George A. French, West Hartford, CT (US); Paul C. Castanho, Rocky Hill, CT (US)

(72) Inventors: Leslie S. Dunham, Lithia, FL (US); Carol A. Swirsky, Branford, CT (US); George A. French, West Hartford, CT (US); Paul C. Castanho, Rocky Hill, CT (US)

(73) Assignee: The Travelers Indemnity Company

(21) Appl. No.: 13/287,565

(22) Filed: Nov. 2, 2011

(51) Int. Cl. G06Q 40/08

(52) U.S. Cl. 705/4

(57) ABSTRACT

Exemplary embodiments provide systems and methods that automatically gather, organize, present, and communicate data and information that aid a claim handler in making an accurate, informed decision regarding whether or not to allow or approve an authorization request, payment, claim, or action associated with a pharmacy insurance claim. Exemplary embodiments include a software application that reduces the effort required and increases the speed and effectiveness of claim handlers by providing organized, immediate access to claim summary and detailed pharmacy information, which streamlines reviews and the request approval process, including payment requests and prior authorization requests. Various embodiments also activate real-time alerts and reminders to claim handlers for various pharmacy claim management tasks.

### FIELD OF THE INVENTION

This invention relates to managing insurance coverage, and more particularly, to managing claims for pharmacy products and services.

### BACKGROUND

Many types of insurance provide coverage for pharmacy expenses, such as the cost of drugs and medications. The amount paid by the insurance provider to a pharmacy for covered pharmacy expenses is often related to the manner in which the expenses are billed to the insurance provider by the pharmacy. For example, prior authorized expenses (i.e., expenses that are approved by the insurer before the drug, medication, etc., is dispensed to the insured claimant and that are electronically billed directly to the insurer (or indirectly through a benefits management partner)) generally cost less for the insurer and the insurer's customer than pharmacy expenses that are not pre-approved and that are billed to the insurer “out of network” through a third-party biller or using a paper bill.

Typically, a pharmacy will use prior authorization and the associated electronic billing if the pharmacist can obtain authorization or approval for a transaction from the insurance company in real time, while the customer waits at the pharmacy counter. If prior authorization cannot be obtained, the pharmacist will often dispense the prescribed medication and complete the transaction, and then bill the insurer with a paper bill or via a third party biller. Or in some cases, the pharmacist may have the customer pay out of pocket for the transaction, and the customer may then contact the insurer for reimbursement.

For example, consider a case in which an injured worker, who is covered by his employer's workers compensation insurance policy and has opened a claim, enters a pharmacy to fill a prescription for pain medication. Before filling the prescription, the pharmacist may contact the insurer to try to obtain prior authorization. In most cases, the pharmacist may enter a prior authorization request in a computer at the pharmacy counter that is connected to an automated pharmacy benefit management system, and the request causes an email to be sent to the insurer. Typically the email specifies the claim number, the claimant, and the medication and prescribing doctor information for the prescription. After requesting the authorization, the pharmacist may be willing, to wait five or ten minutes for a response from the insurer before giving up and dispensing the medication to the injured worker claimant.

At the insurer's, end, when a claim handler receives the prior authorization request email, he or she must quickly decide whether to grant the prior authorization request or deny it. In order to make an informed and proper decision, however, the claim handler must gather relevant information about the claim (such as the claim's present status and history), the claimant, the prescribed medication, the prescribing doctor, the insurer's policies, etc. The claim handler needs such information to accurately determine whether the prescribed medication is safe, adequate, and necessary for the claimant, as well as determining whether the prescription truly is a covered expense at all.

Because the various pieces of information needed by the claim handler are stored in several different systems (e.g., billing systems, editing systems, repricing systems, benefit management systems of partners, policy coverage systems, FDA systems, claim note files, etc.) and in several different formats, gathering it all together may take more time than the pharmacist and customer are willing to wait, especially if the claim handler is inexperienced or if he or she simply did not open the prior authorization request email right away. Moreover, if the claim handler did not think ahead and save useful information in the claim notes or elsewhere in the electronic claim file, then there may be no information available to the claim handler disclosing whether a similar claim or authorization request was previously approved or denied, and no information explaining why a previous decision was made.

As noted above, if the pharmacist does not receive an authorization (or a denial) from the claim handler within a short time, the pharmacist will vary often simply dispense the prescribed meditation to the waiting customer, and bill the insurer after the fact, which results in the insurer paying more for the medication.

Thorough prior authorization review by a claim handler also helps ensure the injured worker's safety, because consideration of the worker's claim history and prescription history may reveal over-prescription of medications (e.g., painkillers) or potential harmful interactions between medications prescribed by different doctors who are unaware of what the others are prescribing.

The present disclosure provides several novel improvements to current pharmacy claim processing and management systems, including improvements that make pharmacy claim management more structured, efficient, cost-effective, automated, and easy to use.

### BRIEF DESCRIPTION OF THE DRAWINGS

The accompanying drawings, which are incorporated in and constitute a part of this specification, illustrate embodiments of the invention and together with the description, serve to explain the principles of the invention. Wherever convenient, the same reference numbers have been used to refer to the same or similar components. In the figures:

FIG. 1 is a block diagram of an exemplary system for managing pharmacy insurance claims, consistent with embodiments of the invention;

FIG. 2 is an exemplary-flow chart for managing pharmacy insurance claims, consistent with embodiments of the invention;

FIG. 3 is a depiction of an exemplary dashboard user interface for managing pharmacy insurance claims, consistent with embodiments of the invention;

FIG. 4 is a depiction of an exemplary user interface for presenting alert tasks related to pharmacy claims, consistent with embodiments of the invention;

FIG. 5 is a depiction of an exemplary user interface for presenting a medication history, consistent with embodiments of the invention;

FIG. 6 is a depiction of an exemplary user interface for presenting medication prescribers, consistent with embodiments of the invention;

FIG. 7 is a depiction of an exemplary user interface for presenting therapeutic letter information, consistent with embodiments of the invention;

FIG. 8 is a depiction of an exemplary user interface for presenting independent pharmacy evaluation information, consistent with embodiments of the invention; and

FIG. 9 is a block diagram of an exemplary computing or data processing system that may be used to implement embodiments consistent with the invention.

### DESCRIPTION OF EMBODIMENTS

In general, embodiments consistent with the present disclosure provide systems and methods that automatically gather, bring together, organize, present, and communicate data and information that aid a claim handler, e.g., adjuster, in making an accurate, informed decision regarding whether or not to allow a pharmacy authorization, payment, claim, or action.

Various embodiments consistent with the present disclosure reduce the effort and increase the speed and effectiveness of claim handlers by providing organized, immediate, access to claim summary and detailed pharmacy information, which streamlines reviews and the request approval process, including processes for payment requests and prior authorization requests. Various embodiments also activate real-time alerts and reminders to claim handlers for various pharmacy claim management tasks.

Although most of the exemplary embodiments in this disclosure are described in the context of workers compensation insurance, embodiments consistent with the invention are not limited to worker's compensation insurance. Other embodiments may be easily applied to other types of insurance that cover pharmacy products and services, such as health care insurance and medical coverage accompanying automobile, insurance.

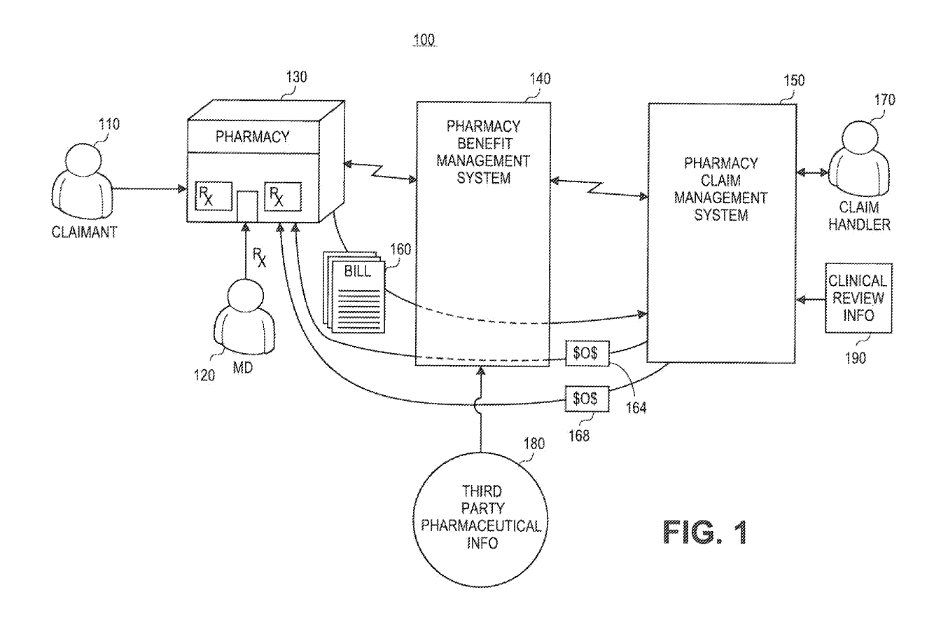

FIG. 1 is a block diagram of an exemplary system 100 for managing pharmacy insurance claims, consistent with embodiments of the invention. As shown in the example of FIG. 1, system 100 includes a pharmacy 130, which is communicatively connected to a pharmacy benefit management system 140, which is communicatively connected to a pharmacy claim management system 150. In various embodiments, the connections between pharmacy 130, pharmacy benefit management system 140, and pharmacy claim management system 150 may be digital communications links or channels that allow computing systems to exchange data with each other and may include a network(s), such as the Internet (not shown).

In the embodiment shown, pharmacy benefit management system 140 may include a computing system, such as a server, maintained by a pharmacy benefit management (PBM) company or organization (such as HealtheSystems™, Caremark/AdvancePCS™, Express Scripts™, etc.) that acts as an administrator of prescription drug programs for insurance companies, and the like. In general, a PBM company contracts with pharmacies to obtain reduced prices that are below standard fee schedules used by third-party billers and paper billers. In some embodiments, pharmacy benefit management system 140 may process and pay prescription drug claims that do not require authorization or approval from a claim handler at the insurance company.

Pharmacy claim management system 150 may include a computing system, such as a server and user workstations, maintained by an insurance company or organization that provides prescription medication coverage or pharmacy coverage.

In the embodiment shown, a claimant 110, such as an injured worker with a worker's compensation insurance claim, may visit pharmacy 130 to fill a prescription written by a physician, such as MD 120. MD 120 may provide the prescription to claimant 120, who carries it to pharmacy 130, or MD 120 may provide the prescription to pharmacy 130 by some other means, such as telephoning, faxing, or sending an email.

In any case, at the pharmacy counter and before dispensing the prescribed medication, a pharmacist may enter information about the prescription and about the insurance claim into a computer that is communicatively connected to pharmacy benefit management system 140 and send the information in a request for prior authorization to pharmacy benefit management system 140. As this is happening, claimant 110 may be waiting at the pharmacy counter for the pharmacist to fill the prescription.

In this example, because the pharmacist has transmitted a request for prior authorization, pharmacy benefit management system 140 will notify pharmacy claim management system 150 and (directly or indirectly) claim handler 170 of the pending request. In various embodiments, this notification from pharmacy benefit management system 140 may be implemented in the form of a Prior Authorization Request alert message that appears on a user interface screen of a workstation used by claim handler 170 to interact with pharmacy claim management system 150; and/or in the form of an instant message, such as an SMS or other text message, for example, that pops up on the user interface screen of a mobile device or workstation used by claim handler 170; and/or in the form of an email to claim handler 170, and/or in the form of a phone call to a telephone associated ‘with’ claim handler 170 (e.g., using a computer-generated voice to read the text used in the email or IM) and/or in the form of a change to a user interface (e.g., an increase to a task count displayed on a dashboard screen). The foregoing are various examples of electronic notifications. Other types of notifications may also be used. In addition, notifications may be sent for other types of authorization requests, as described herein.

In some embodiments, pharmacy benefit management system 140 may address the notification directly to claim handler 170. In other embodiments, pharmacy benefit management system 140 may address the notification to pharmacy claim management system 150, and include claim information sufficient for pharmacy claim management system 150 to identify the appropriate claim handler 170 and then create a notification that it sends to claim handler 170. Other means for notifying claim handler 170 may also be used.

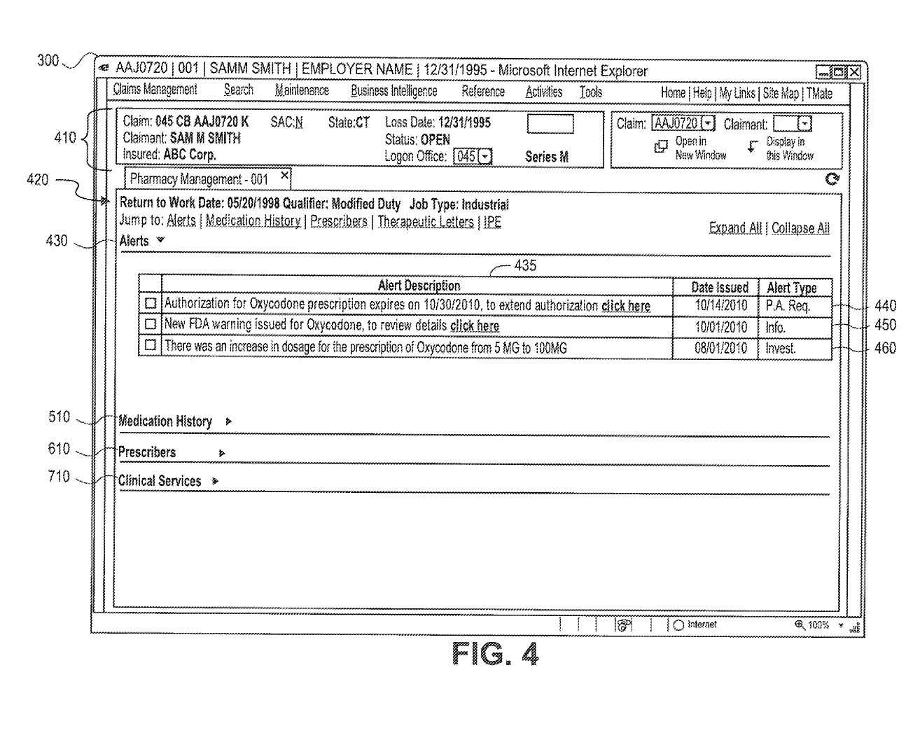

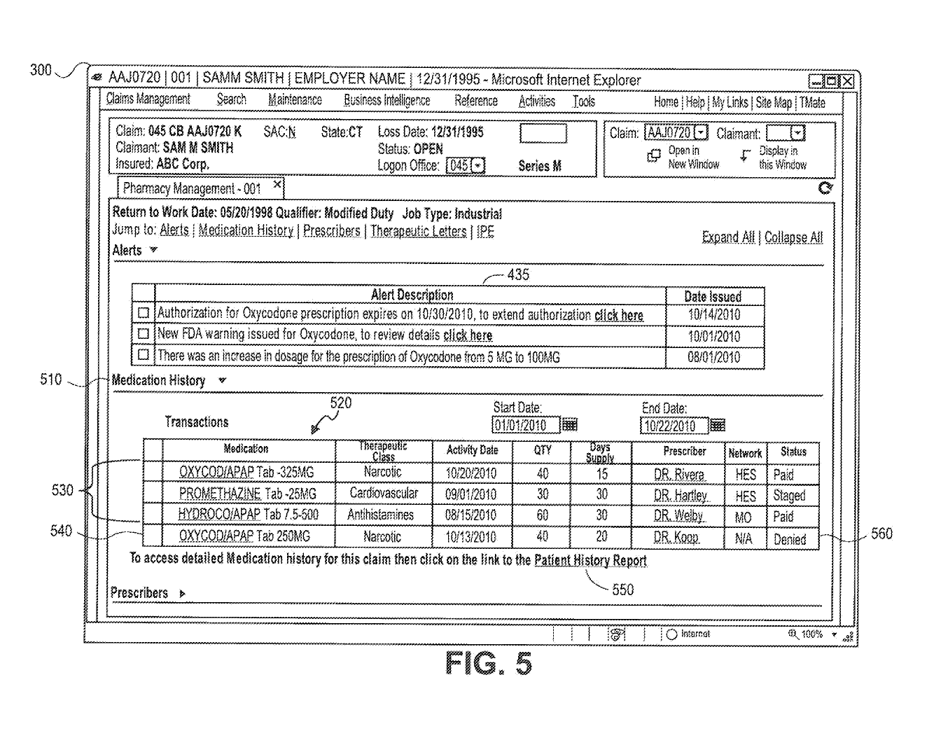

In various embodiments, the notification (e.g., IM, text, or email) may include control means, such as a clickable link, that functions to invoke or execute pharmacy claim management system 150 such that pharmacy claim management system 150 displays, to claim handler 170, information relevant to the claim and the request for prior authorization. For example, clicking on a link in the notification may immediately invoke a user interface 300, such as that shown in FIG. 4, populated with information 410, 420, and 435 corresponding to claimant 110 and the claimant's worker compensation claim, and including controls 430, 510, 610, 710 for accessing additional information related to the claim and claimant, such as the claim information illustrated in FIGS. 5-8.

Referring again to FIG. 1, in various embodiments, the information used to control the functionality and populate the displays generated by pharmacy claim management system 150 may be gathered from various sources, such as pharmacy benefit management system 140, clinical review information source 190, third party pharmaceutical information source 180, and pharmacy bills 160 from pharmacy 130.

Thus, pharmacy claim management system 150 may quickly and efficiently organize and present to claim handler 170 all the information that is accessible to it regarding claimant 110 and his (or her) pharmacy claim. Typically, claim handler 170 will consult several pieces of information in deciding whether to approve or deny an authorization request, such as whether the claim file is still open, whether the medication is on the list of prescription drugs covered by claimant 110's worker compensation, whether MD 120 is authorized to prescribe medications under claimant's 110 claim, whether information from an internal clinical review 190 or from a third party pharmaceutical information provider 180, (e.g., the FDA) indicates that the prescribed medication should not used by a category of people that includes claimant 110, and various other factors. In the illustrated embodiment, third party pharmaceutical information provider 180 is shown providing information to pharmacy benefits management system 140, which in turns provides the information to pharmacy claim management system 150. In other embodiments, third party pharmaceutical information provider 180 may provide information directly to pharmacy claim management system 150.

In addition, claim handler 170 may consult a list or display of previous authorization decisions that were made for the claim, as these historical decisions typically provide very reliable guidance regarding how to handle a similar pending prior authorization request because the claim handler has already considered the relevant information and determined how to proceed in the recent past.

In various embodiments, pharmacy claim management system 150 may provide a control, such as a link or button, that claim handler 170 may click on to interface with pharmacy benefit management system 140. After reviewing the relevant pharmacy claim information presented by pharmacy claim management system 150, claim handler 170 may use this control to enter his (or her) decision, such as “approve the prior authorization request” or “deny the prior authorization request” into pharmacy benefit management system 140, which in turn communicates the decision to pharmacy 130 and the pharmacy counter computer of the pharmacist. In other embodiments, pharmacy claim management system 150 may provide a control, such as a link or button, that claim handler 170 may use to transmit the decision directly to pharmacy 130, without interfacing with pharmacy benefit management system 140.

In some embodiments, when the decision is communicated to pharmacy 130, pharmacy benefit management system 140 transmits a confirmation communication, such as an XML transaction, to pharmacy claim management system 150, which updates the claim information as appropriate for the decision. For example, upon receipt of the confirmation communication, pharmacy claim management system 150 may store information that the prior authorization request for the prescription of claimant 110 was approved or denied, and remove any pending alerts or notifications related to that request.

As shown in the embodiment of FIG. 1, if pharmacy 130 does not receive an authorization (or a denial) responsive to its request for prior authorization from claim handler 170 within a reasonable time period for claimant 110 to wait, pharmacy 130 may dispense the prescribed medication to claimant 110 without prior authorization, and send a non-prior-authorized bill, such as a paper bill, to the insurer (e.g., Via pharmacy benefit management system 140). In various embodiments, this scenario may result in the insurer paying pharmacy 130 more for the prescribed medication because the transaction is considered “out of network” (i.e., not eligible for discounts contracted for by pharmacy benefit management system 140) when pharmacy bill 160 is implemented using a third party electronic bill or a paper bill instead of using electronic prior authorization via pharmacy benefit management system 140. On the other hand, this scenario may result in pharmacy 130 not being paid at all by the insurer operating pharmacy claim management system 150 because the claim corresponding to non prior-authorized pharmacy bill 160 (e.g., a paper bill) may be rejected for any of a variety of reasons well known in the art, whereas a prior authorization guarantees payment by the insurer. As mentioned, in some embodiments, pharmacy 130 may employ an “out-of-network” third-party biller instead of billing via pharmacy benefit management system 140. In other embodiments, claimant 110 may pay out of pocket if pharmacy 130 cannot obtain a timely prior authorization from claim handler 170.

In the embodiment shown in FIG. 1, in response to a pharmacy bill 160, the insurer, for example using pharmacy claim management system 150, may approve and/or send a payment 164 indirectly to pharmacy 130 via pharmacy benefit management system 140. Alternatively, the insurer may approve and/or send a payment 168 directly to pharmacy 130.

One of ordinary skill will recognize that elements may be added to, removed from, or modified within system 100 without departing from the principles of the invention. For example, systems consistent with the invention may have any number of pharmacies 130, multiple claim handlers 170 for each claim, or a claim handler 170 and a medical care manager, such as a nurse (not shown), for each claim. For another example, some embodiments may eliminate pharmacy benefit management system 140 and/or move its functionality to pharmacy claim management system 150, such that pharmacy claim management system 150 interfaces directly with pharmacy 130. For yet another example, pharmacy bill 160 may go directly to pharmacy claim management system 150, instead of first being processed (as shown) by pharmacy benefit management system 140, which in some embodiments converts the bill's information to electronic data that is passed to pharmacy claim management system 150.

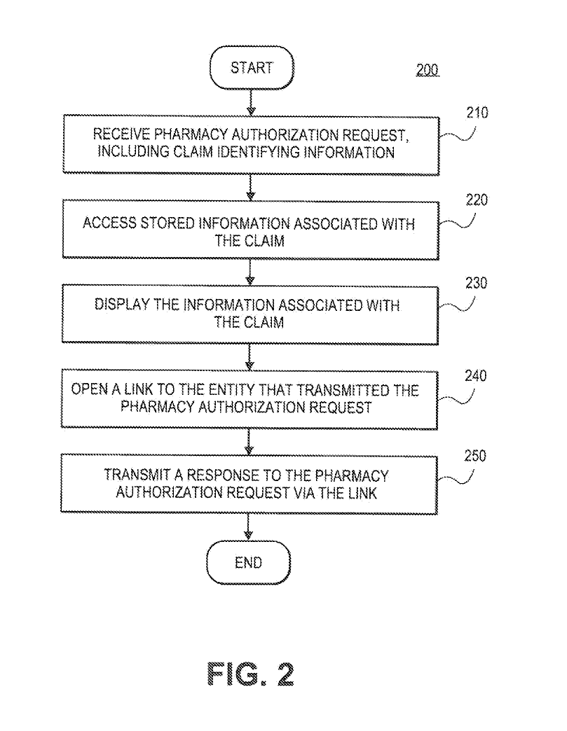

FIG. 2 is an exemplary flow chart 200 for managing pharmacy insurance claims, consistent with embodiments of the invention. In various embodiments, flow chart 200 may be implemented in hardware, software, or firmware. For example, flow chart 200 may be implemented by a computing system, such as a server computer, executing a software application or applications, as part of pharmacy claim management system 150.

As shown in FIG. 2, flowchart 200 begins by receiving a pharmacy authorization request, which includes claim identifying information (block 210). For example with reference to FIG. 1, pharmacy claim management system 150 may receive a request for prior authorization for filling a prescription, which is transmitted in the form of an electronic communication, such as an XML transaction, from pharmacy benefit management system 140 or from pharmacy 130. For another example, pharmacy claim management system 150 may receive a request to authorize payment of a pharmacy bill for prescribed medications. For yet another example, pharmacy claim management system 150 may receive a request to authorize the implementation of a pharmacy evaluation service for a pharmacy claim. Other types of requests are possible.

In various embodiments, the claim identifying information may include the name of a claimant 110, the name of the insured party, a claim number, and the like.

Next, flowchart 200 accesses stored information associated with the claim (block 220). For example, pharmacy claim management system 150 may read data stored in a local or remote data structure or database by querying the database using the claim identifying information received with the request in block 210. For another example, pharmacy claim management system 150 may retrieve data from clinical review information source 190 and/or third party pharmaceutical information source 180 and/or from pharmacy benefit management system 140, or some other information source.

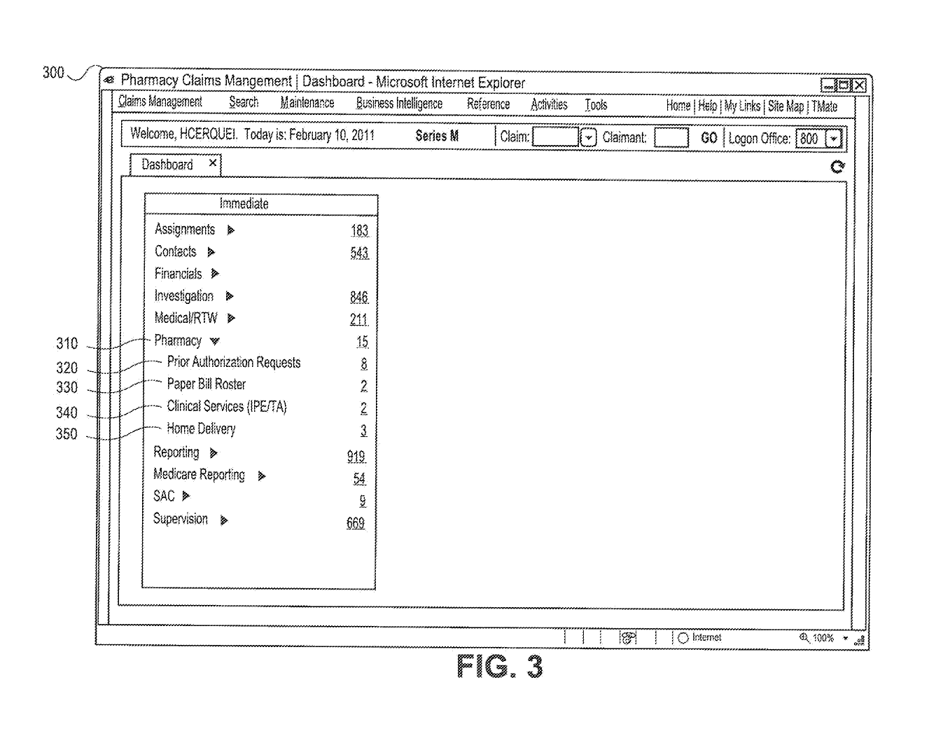

At block 230, flowchart 200 displays the information associated with the claim. For example, pharmacy claim management system 150 may organize the information obtained from various sources into fields on a graphical user interface that is displayed by a screen, monitor, or other output device associated with pharmacy claim management system 150. In some embodiments, the information may be transmitted to a remote device, such as a hand held computing device, (e.g., a smart phone), which displays the information for a claim handler 170. In some embodiments, the information associated with the claim may be used to populate a user interface 300 as shown in FIGS. 3-8.

At block 240, flowchart 200 next opens a communication link, communication channel, or the like, to the entity that transmitted the pharmacy authorization request received in block 210. For example, in some embodiments, a link or control may be provided that when activated by claim handler 170, provides an interface to pharmacy benefit management system 140 or directly to pharmacy 130. Claim handler 170 may activate the link after analyzing the displayed information associated with the claim and reaching a decision regarding whether to approve the authorization request or deny the authorization request.

At block 250, flowchart 200 transmits a response to the pharmacy authorization request via the opened link. For example, in some embodiments where the link provides claim handler 170 with access to pharmacy benefit, management system 140, claim handler may enter a response of, for example, “authorized” or “denied” into pharmacy benefit management system 140. In such embodiments, pharmacy benefit management system 140 may then communicate the response to pharmacy 130. In various embodiments, the response is not limited to a binary choice; instead the claim handler 170 may provide, via the link, a detailed response with explanation, such as authorization granted for this dispensing and for one refill, authorization granted for a single dispensing only, authorization granted for the next 12 months, and the like.

In various embodiments, at least blocks 210-230 may be performed automatically by a computing system(s), which results in decision-support information relevant to a claim request being made available to a user, such as claim handler 170, almost instantaneously. Moreover, in various embodiments, this information is presented in a concise, well-organized, easy-to-understand fashion, such as that illustrated in FIGS. 3-8. Such embodiments enable pharmacy 130 to process and receive an electronic, real-time acknowledgement that an insurer will pay for a prescribed medication before pharmacy 130 dispenses medication to the patient.

One of ordinary skill will recognize that blocks may be added to, deleted from, modified, or reordered in flow chart 100 without departing from the scope of the invention. For example, block 240 may be deleted, and the response of stage 250 may be transmitted via email or an instant message, or the like.

FIG. 3 is a depiction of an exemplary dashboard user interface for managing pharmacy insurance claims, consistent with embodiments of the invention. In various embodiments, user interface 300 may be generated by hardware, software, or firmware. For example, user interface 300 may be generated by a computing system, such as a server computer, executing a software application or applications, as part of pharmacy claim management system 150. For another example, user interface 300 may be generated by a client computer used by claim handler 170 and executing a software application or applications, in communication with pharmacy claim management system 150.

In the embodiment shown, at a top dashboard level, user interface 300 presents claim management navigation information and controls to a user, for instance a claim professional, such as claim handler 170 or a medical care manager (e.g., a nurse) employed by an insurer. In various embodiments, a claim professional may manually enter the application that generates user interface 300, but perhaps more commonly, the user will be directed to the dashboard screen of FIG. 3 from a control, link, or task in another application, or from a control, link or task that is part of a notification to the claim professional, such as an email or instant message related to a request for authorization from a pharmacy, or the like.

As shown in this example, the dashboard level displays a “Pharmacy” item 310 on a menu of items or tasks that are organized for “immediate” attention by a claims professional. Clicking on the triangular control next to the “Pharmacy” item 310, causes the application to display four pharmacy sub-items or tasks, “Prior Authorization Requests” 320, “Paper Bill Roster” 330, “Clinical services (IPE/TA)” 340, and “Home Delivery” 350. Next to each of the sub-items is a numeral, which is also a control link, indicating the number of each type of sub-item that is pending in the system and requiring attention from the user.

In various embodiments, the dashboard of FIG. 3 may be populated with items/tasks and sub-items/tasks 310-350 according to data obtained from various sources, including for example, a pharmacy benefit management system 140 and/or a pharmacy 130. In some embodiments, a pharmacy benefit management system 140 may send sub-items/tasks to pharmacy claim management system 150 for the purpose of raising awareness in a claim professional when certain conditions exist, prompting actions that result in better customer service and cost containment. In such embodiments, a computing system of pharmacy benefit management system 140 may communicate sub-items/task data to pharmacy claim management system 150 using electronic data transfer techniques, such as HML feeds.

In the embodiment shown in FIG. 3, there are eight “prior authorization request” tasks or sub-items 320 pending. As explained above, a prior authorization request is a request for a determination as to whether an insurer will allow or not allow a medication, before the prescription is filled. A prior authorization request typically is generated in association with a new point of sale transaction at a pharmacy, and typically requires immediate review by a claim professional.

In the embodiment illustrated, a claim professional using the dashboard of FIG. 3 may click on the “8” control/link next to the prior authorization request item 320, and in response, pharmacy claim management system 150 will display on user interface 300, a pharmacy management screen, for example as illustrated in FIGS. 4-8.

In various embodiments, the pharmacy management screen may provide a claim professional with all the available information relevant to a pharmacy claim, such as information regarding what transactions have been allowed on the claim in the past, information showing the various medications that the patient is receiving, information and warnings related to any of the medications, etc. After examining and considering the displayed information related to a claim, the claim professional can make an informed decision regarding how to dispose of pending tasks/sub-items related to the claim, such as a decision, regarding whether to approve a request for prior authorization from a pharmacist. In various embodiments, the pharmacy management screen also provides a control or other means for transmitting the decision, either directly or indirectly, to the entity that requested the decision, such as a pharmacy 130.

In various embodiments, the counts (e.g., the “8” next to prior authorization requests 320) of the dashboard may be updated in real time, or near real time, as corresponding data and messages are received by pharmacy claim management system 150. Thus, a claim professional(s) responsible for a claim is notified onscreen in real time to events and tasks that require attention, such as when an injured worker is trying to fill a prescription and the pharmacy is requesting prior authorization. In addition to the onscreen dashboard notification, the claim professional may be notified by other means, such as an email or instant message containing a link that brings up the pharmacy management screen for the claim.

When a sub-item/task is resolved—in this example when a decision regarding a prior authorization request is communicated to the requesting pharmacist-pharmacy claim management system 150 reduces the count for that task shown on the dashboard screen (e.g., from 8 to 7 in this example).

As shown in FIG. 3, there are two “paper bill roster” tasks or sub-items 330 pending. In a manner similar to that described above with respect to the “prior authorization request” tasks or sub-items 320, a claim professional using the dashboard of FIG. 3 may click on the “2” control/link next to the paper bill roster item 330, and in response, pharmacy claim management system 150 will display on user interface 300, the pharmacy management screen, for example as illustrated in FIGS. 4-8. Although illustrated as a “paper” bill roster in the embodiment shown, in various embodiments, “paper bill roster” tasks 330 may also include other pharmacy transactions that require review by a claim professional, such as payment stage delete transactions.

Also as described above, the pharmacy management screen may provide a claim professional with all the available information relevant to the pharmacy claim from, in this case, a paper bill received by the insurer. After examining and considering the displayed information related to the paper bill's claim, the claim professional can make an informed decision regarding how to dispose of pending paper bill roster task/sub-item, including on a medication by medication basis if the paper bill contains multiple medications. The informed decision by the claim professional may include an action such as approving payment of the paper bill, denying payment, staging payment for a later time, etc.

In various embodiments, the paper bills, converted to electronic format, may be provided by a pharmacy benefit manager, such as pharmacy benefit management system 140, directly by a medication provider, such as pharmacy 130, or by a third-party biller employed by pharmacy 130, among other sources. When the data representing a paper bill is received by pharmacy claim management system 150, the system notifies the appropriate claim professionals as described above, including by increasing the count next to paper bill roster item 330. In some embodiments, paper bill sub-items/task may be resolved by accessing pharmacy benefit management system 140 and entering an action or instruction for resolution (e.g., pay the paper bill). In such embodiments, pharmacy claim management system 150 may provide a communication link to pharmacy benefit management system 140 which puts the claims professional into the appropriate paper bill roster interface of pharmacy benefit management system 140, where the claim professional may enter a response to complete the task. In such embodiments, pharmacy benefit management system 140 may automatically communicate with pharmacy claim management system 150, for example using an XML feed, to confirm the resolution of the paper bill task, and pharmacy claim management system 150 may in turn reduce the count shown next to paper bill roster item 330 on the dashboard screen.

Next as shown in FIG. 3, there are two “clinical services (IPE/TA)” tasks or sub-items 340 pending. In a manner similar to that described above with respect to the “prior authorization request” tasks or sub-items 320, a claim professional using the dashboard of FIG. 3 may click on the “2” control/link next to the clinical services (IPE/TA) sub-item 340, and in response, pharmacy claim management system 150 will display on user interface 300, the pharmacy management screen, as illustrated in FIGS. 4-8.

“IPE” means Independent Pharmacy Evaluation, which is an optional case review service that may be performed by a medical staff of the insurer and may result in a recommendation regarding a change in the pharmaceutical treatment and/or coverage that is being provided to a claimant. IPEs are recommended for some candidate cases that meet specific criteria. The system places IPE tasks 340 on the dashboard screen of FIG. 3 when an existing claim is identified (i.e., the claim matches a set of criteria), as a candidate for an IPE or a Therapeutic Alert letter, and requires a claim professional's decision and response, because such clinical services may result in a charge to the insured customer. Often, however, this charge is more than offset by the amount saved by IPE recommendations to change or eliminate certain medications, and by the harmful effects prevented for claimants whose medications may negatively interact, etc.

In a manner similar to that described above, the pharmacy management screen may provide a claim professional with all the available information relevant to the case or claim that has been recommended for an IPE. After examining and considering the displayed information related to the case, the claim professional can make an informed decision regarding whether to proceed with an IPE. For instance, a claims professional may reject an IPE recommendation because he is about to settle the claim.

“TA” means Therapeutic Alert, and is a clinical service that has processing somewhat similar to an IPE. A Therapeutic Alert is an informational letter related to medication(s) formulated by a medical staff of the insurer, which is sent out to doctors who are prescribing that medication(s). In many states, a TA letter may be sent out without claim professional approval whenever a claim meets a certain criteria (i.e., when a claimant is prescribed a relevant medication). For example, there may be a Celebrex. TA letter because Celebrex was recalled, and if a claimant is receiving Celebrex, then a TA letter would be automatically sent out to the prescribing doctor indicating that the insurer has concerns about the use of this medication, and perhaps recommending alternatives.

In other states, called ex parte states, a claim professional must approve a therapeutic alert letter before it may be sent to a physician. In such states, pharmacy claim management system 150 populates the dashboard screen with a request for approval that a TA letter be sent out.

The last pharmacy task or sub-item shown in FIG. 3, are the “Home Delivery” tasks or sub-items 350 that are pending. The system places Home Delivery tasks 350 on the dashboard screen of FIG. 3 when an existing claim is identified (i.e., the claim matches a set of criteria), as a candidate that can be converted to mail order delivery, and requires a claim professional's decision and response. As described previously with respect to the other pharmacy sub-items, a claim professional using the dashboard of FIG. 3 may click on the “3” control/link next to the home delivery sub-items 350, and in response, pharmacy claim management system 150 will display on user interface 300, the pharmacy management screen, for example as illustrated in FIGS. 4-8. The pharmacy management screen may provide a claim professional with all the available information relevant to the case or claim that has been recommended for a mail order or home delivery program. The insurer must first obtain permission from the injured worker claimant before converting his prescription service from pharmacy visit to home delivery (e.g., mail order), and this task 350 is a prompt for the claim professional (or some other agent of the insurer) to contact the claimant and ask for permission. After examining and considering the displayed information related to the case, the claim professional can make an informed decision regarding whether the claimant is a good candidate for enrollment in mail order or home delivery, and, if so, the claim professional can authorize contacting of the injured worker to ask for permission to switch to home delivery of prescription medications.

One of ordinary skill will recognize that the exemplary dashboard screen shown in FIG. 3 is necessarily simplified for conciseness and clarity of explanation, and that information and controls may be rearranged or presented differently without departing from the scope of the invention.

FIG. 4 is a depiction of an exemplary user interface 300 for presenting alert tasks and information related to pharmacy claims, consistent with embodiments of the invention. In various embodiments, user interface 300 may be generated by hardware, software, or firmware. For example, user interface 300 may be generated by a computing system, such as a server computer, executing a software application or applications, as part of pharmacy claim management system 150. For another example, user interface 300 may be generated by a client computer used by claim handler 170 and executing a software application or applications, in communication with pharmacy claim management system 150.

The embodiment shown in FIG. 4 depicts a pharmacy management screen configuration of user interface 300, with the “Alerts” section 430 selected for display. The pharmacy management screen presents claim-specific information and navigation controls to a user, for instance a claim professional, such as claim handler 170 or a medical care manager employed by an insurer. In various embodiments, a claim professional may manually enter the application that generates user interface 300 and navigate to the pharmacy management screen of FIG. 4, but perhaps more commonly, the user will be directed to the pharmacy management screen of FIG. 4 by a control, link, or, task in another application (such a medical claim management application), by a control, link, or task in another screen of the pharmacy claim management system 150 (such as the dashboard screen of FIG. 3), or by a control, link or task that is part of a notification to the claim professional, such as an email or instant message related to a request for authorization from a pharmacy, or the like.

As shown in the example of FIG. 4, when interface 300 is configured to display the pharmacy management screen, the screen may include a claim identification section 410, which specifies a claim and claimant, including information reflecting the claim number, the name of the claimant, the insured party (e.g., the employer covered by worker compensation insurance), the date of the loss, etc. As shown, the pharmacy management screen may also provide a claimant status section 420 that displays the current status of a claimant 110, including, for example, work-related information such as the claimant's return to work date: (if it has been determined), the claimant's work duty qualifier, (for example, any restrictions such as desk only, light duty, full duty, etc.), and the claimant's job type (for example, industrial, heavy labor, driver, sedentary, etc). In various embodiments, claimant status section 420 may, also display other relevant information, such as the physical demands of the claimant's job (e.g., driving, lifting, etc.). In some embodiments, this information may come from case notes created and maintained by a claim handler 170.

The information presented to a claim professional at the same time in sections 410 and 420 may be very useful for making pharmacy related decisions because many workers compensation claimants return to work while still taking medications. Using this information, particular from section 420, a claim professional can identify potential problems, especially work-related problems, that may be caused by medications, and take corrective actions. For example, if an injured worker is returned to work while taking a drug that causes drowsiness, that worker should not be allowed to perform driving jobs, such as a truck driver or forklift driver, where the worker's expected duty (e.g. regular duty-driving) may be shown in the “Qualifier” field of claimant status section 420, and the worker's job (e.g., heavy equipment driver) may be shown in the “Job Type” field of section 420. When a claim professional recognizes a potential problem, he may notify the insured (e.g., the employer) with a warning about assigning certain job duties to the claimant because of pharmaceutical concerns (e.g., this employee is taking medications that cause drowsiness, so he may not yet be suited to perform his regular job as a truck driver).

In the configuration of the pharmacy management screen shown in FIG. 4, an alerts section 430 is selected and its details are displayed, and a medication history section 510, prescribers section 610, and clinical services section 710 are not selected.

As shown, alerts section 430 includes an alert table 435, which shows all the pending alerts related to this claim. In various embodiments, the claim professional must act on, or at least read, each pending alerts in order to clear it from alert table 435. In various embodiments, an alert displayed on this configuration of the pharmacy management screen may contain a control or hyperlink that brings the claim professional to another interface of the same application program, to another application hosted by pharmacy claim management system 150 or to an application of an external vendor or partner (such as pharmacy benefit management system 140) to complete an activity prompted by the alert, such as pharmacy payment approval or denial; pharmacy prior authorization approval or denial, pharmacy fill authorization, mail order authorization, clinical evaluation authorization, etc. Thus, alerts raise awareness for the claim professional when certain conditions exist, and they prompt action, resulting in better customer service and cost containment opportunities. Alerts may also facilitate proactive management of a claimant's profile, such as, the ability to define future prior authorization instructions.

As shown in exemplary alert table 435, there are three alerts pending for the claim identified in section 410. The first exemplary alert, shown on the top row 440 of table 435, is a claim-specific prior authorization request for an Oxycodone prescription. Alert 440 includes a description in the “Alert Description” column of alert table 435; a date the alert was issued, in the “Date Issued” column of alert table 435; and a type, in the “Alert Type” column of alert table 435. The alert type column may contain any of several values describing what kind of alert appears in that row, such as a prior authorization (PA) request alert, an informational alert, a payment stage delete (PSD) alert, an investigational alert, a bill roster alert, a home delivery alert, an IPE alert, a TA alert, etc.

As shown, in the past the claim professional has allowed Oxycodone as a covered medication, and this alert, which was automatically generated by the system, notifies the claim professional that the current allowance is about to expire in 2 weeks. This is an example of a proactive alert—it requires the claim handler to consider whether, if the injured worker claimant attempts to refill the Oxycodone prescription after Oct. 30, 2010, the claim professional would allow it. Proactive alerts may be contrasted to real time alerts, such as those described previously with respect to a claimant waiting at the pharmacy while the pharmacist requests a prior authorization. As noted, an automated system, such as pharmacy claim management system 150 or pharmacy benefit management system 140, may generate proactive alerts based on expiration date information, and the like, from a claim file.

In some embodiments, wherein the data for various alerts comes from an external source such as pharmacy benefit management system 140, the data may be received in an electronic communication format, such as an XML transaction.

The second exemplary alert 450 shown in alert table 435 is a non-claim-specific alert, unlike the first alert 440. The content data for this non-claim-specific type of alert may be obtained from a third party pharmaceutical information source 180, such as the FDA. In some embodiments, the distribution parameters for this type of alert (e.g., which claims to send it to) may be determined by querying a claims database for claims that match the content date (e.g., in this case, claims that include Oxycodone as a prescribed medication). In other embodiments, non-claim-specific or informational alerts may simply be broadcast to all open claims, regardless of whether they are directly related to a prescribed medication associated with each claim.

The third exemplary alert 460 shown in alert table 435 is another claim-specific alert, and it notifies the claim professional (e.g., a nurse) assigned to this claim of an increase in dosage for the claimant that may need to be investigated. Numerous other forms, types, and distributions of alerts may also be used.

In various embodiments, claim-specific alerts, such as alerts 440 and 460, may have to be resolved by an action performed by claim handler 170, and they may remain displayed in alert table 435 until they are resolved. For example, in the case of alert 440, claim handler 170 may have to extend the expiration date of a prior authorization beyond its current expiration date in order to clear alert 440 from alert table 435. A non-claim-specific alert 450, on the other hand, may be automatically cleared by the system without any required action by the claim handler. For example, the system may clear informational alert 450 after a predetermined period (e.g., 45 days) since its issuance, or after it has been displayed to a claim handler 10 different times. Other criteria for clearing may also be used.

One of ordinary skill will recognize that the pharmacy management screen shown on FIG. 4 is necessarily simplified for conciseness and clarity of explanation, and that information and controls may be rearranged or presented differently without departing from the scope of the invention.

FIG. 5 is a depiction of an exemplary user interface 300 for presenting a medication history, consistent with embodiments of the invention. The embodiment shown in FIG. 5 depicts another pharmacy management screen configuration, of user interface 300, with the “Medication History” section 510 selected for display. In various embodiments, a claim professional will access the pharmacy management screen of FIG. 5 via a control, link, or task in another application (such a medical claim management application), via a control, link, or task in another screen of the pharmacy claim management system 150 (such as the dashboard screen of FIG. 3), or via a control, link or task that is part of a notification to the claim professional, such as an email or instant message related to a request for authorization from a pharmacy, or the like.

In various embodiments, Medication History section 510 of the pharmacy management screen generally will list all pharmacy payments and denials for the claim specified in section 410. In the implementation shown, the pharmacy transactions for the claim are presented in a pharmacy transaction table 520, which provides information regarding each prescribed medication, the therapeutic class of the medication, the date each prescription was filled (or attempted to be filled), the prescription quantity, the days supply, the prescribing physician, the network indicator, and the status of the prescription transaction. In the example shown, the network indicator reflects the source of the bill for the prescription, such as an in-network pharmacy benefit management partner, a mail order medication provider, an out-of-network bill (e.g., a paper bill from a pharmacy) etc. Further in the example shown, the transaction status column reflects the insurer's coverage decision regarding the prescription. In the example shown, the status column indicates that the first three prescriptions listed (530) were authorized for payment, as indicated by the status indicators “paid” and “staged” (meaning the prescription is authorized but no yet paid). In the example shown, the fourth listed prescription (540) was “denied” (560) (i.e., not authorized for payment under this claim). Other status indicators may also be used, such as “credit,” meaning the prescription was dispensed by a pharmacist, but not picked up by the claimant within 10 days, so the medication was returned to stock and a credit issued by the pharmacy, “credit pending,” “insufficient funds,” “pending credit reversal,” and the like.

The information in pharmacy transaction table 520 (e.g., which prescriptions were previously authorized and which were denied) may assist a claim professional in deciding what action to take on several types of pending tasks, such as whether to approve or deny a prior authorization request, and whether to pay or deny a bill for a filled prescription. Using the display shown in FIG. 5, a claim professional can easily and effectively compare medications on a current pharmacy invoice or authorization request with his previous payment/authorization/denial decisions to more effectively and accurately manage the pending decision.

In some embodiments, each entry in pharmacy transaction table 520 may include controls or links that a user may activate to retrieve and display data providing further details of a transaction, (such as the reason for denial recorded by the claim professional), information about each listed medication, (such as NDC number, whether it is a generic or a brand product, the generic product name, a multisource indicator, side effects, etc.), information about the prescriber (such as DEA registration number, address, phone number, email address, etc.), a copy of the actual bill, and the like.

The embodiment shown in FIG. 5 includes a patient history report control or link 550, which a user may activate to display additional details of the medication history for the claim, such as the role of each prescriber (e.g., case managing physician, referred specialist, etc.). In various other embodiments, other links or controls may be added to medication history section 510, such as a link or control to add a prescriber to a list of non-authorized prescribers for this claim (not shown).

In various embodiments, the data used to populate pharmacy transaction table 520 may be stored in a database or data structure maintained by pharmacy claim management system 150, which may, before storage, have accessed and retrieved at least some of the data from various sources, including pharmacy benefit management system 140, a billing system that processes pharmacy bills 160, a payment processing subsystem associated with pharmacy claim management system 150, and the like.

One of ordinary skill will recognize that the pharmacy management screen shown on FIG. 5 is necessarily simplified for conciseness and clarity of explanation, and that information and controls may be rearranged or presented differently without departing from the scope of the invention. For example, a “Status Date” column may be added to pharmacy transaction table 520 to display a date associated with each entry in the “Status” column.

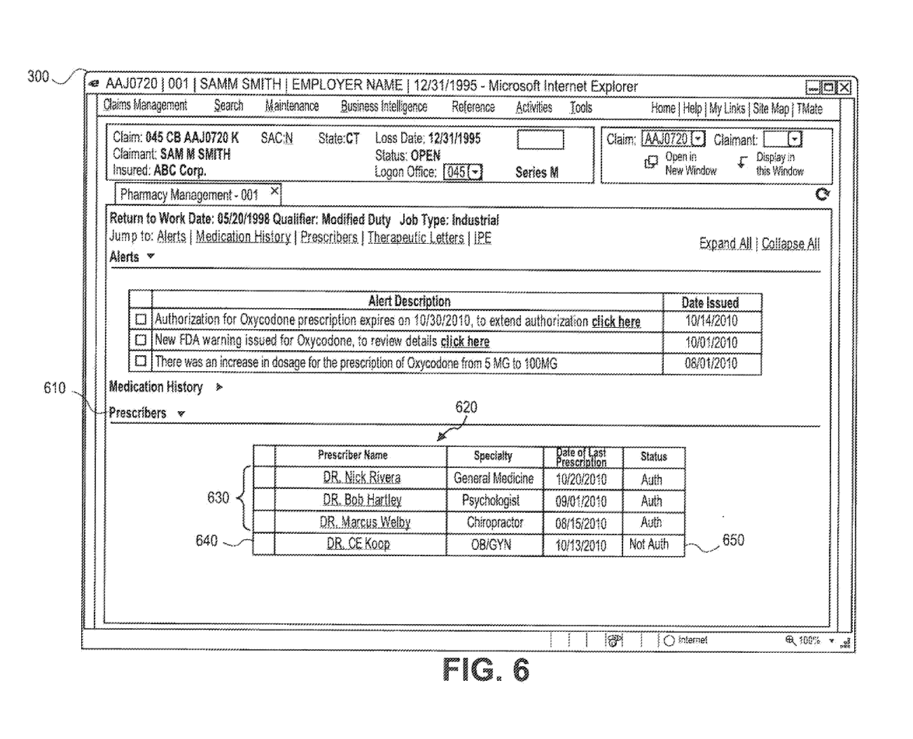

FIG. 6 is a depiction of an exemplary user interface 300 for presenting medication prescribers, consistent with embodiments of the invention. The embodiment shown in FIG. 6 depicts another pharmacy management screen configuration of user interface 300, with the “Prescribers” section 610 selected for display. In various embodiments, a claim professional will access the pharmacy management screen of FIG. 6 via a control, link, or task in another application (such a medical claim management application), via a control, link, or task in another screen of the pharmacy claim management system 150, (such as the dashboard screen of FIG. 3), or via a control, link or task that is part of a notification to the claim professional, such as an email or instant message related to a request for authorization from a pharmacy, or the like.

In various embodiments, Prescribers section 610 of the pharmacy management screen generally will list all prescribers of medications associated with the claim specified in section 410. In the implementation shown, the prescribers associated with the claim are presented in a prescribers table 620, which provides information regarding each prescriber's name, medical specialty, date of the last prescription written, and the status of the prescription transaction. In other embodiments, fewer columns may be presented—for example the specialty column may be eliminated. In the example shown, as indicated in the status column, the first three prescribers listed (630) were authorized or approved by a claim professional, while the fourth listed prescriber (540) was not authorized or approved (650) to write prescriptions under the coverage of this claim. Other status indicators may also be used.

In various implementations, a claim professional may assign a status to a prescriber when the prescriber initially appears in the system. For example, a claim professional may assign an “authorized” status to an in-network doctor that was assigned by the insurer to manage this particular workers comp injury claim, because a managing doctor is expected to prescribe medications for a claimant. In general, a claim professional will authorize only prescribers that are treating the claimant in connection with the covered loss, e.g., in connection with a worker's compensation injury or claim. And, a claim professional generally will not authorize a claimant's other doctors, who are not treating in connection with a worker's compensation injury or claim, such as a general practitioner, cardiologist, etc.

The information displayed in FIG. 6 is organized to provide another perspective on the claim history for a claim professional who is making pharmacy authorization decisions and the like. For example, if a claim professional is reviewing a new prescription bill to decide whether or not to authorize payment, the screen of FIG. 6 will quickly and clearly indicate whether the prescribing physician has been previously authorized, to treat under this claim coverage. And if so, the claim professional may regard this as evidence in favor of paying the bill instead of denying it. Similarly, the opposite might be true if the prescription under review was written by a physician who was previously denied authorization to treat under this claim coverage. Thus, if a prior authorization request or pharmacy bill is received that comes a non-authorized doctor, as displayed in FIG. 6, then the claim professional will not approve the request or pay the bill, because it is almost certainly not a covered treatment related to the workers compensation claim.

In some embodiments, pharmacy claim management system 150 and/or pharmacy benefit management system 140 will automatically (without any action from a claim professional) reject a prior authorization request from a pharmacy 130, if the prescribing doctor has been assigned a status of “not authorized,” as, shown in prescribers table 620.

One of ordinary skill will recognize that the pharmacy management screen shown on FIG. 6 is necessarily simplified for conciseness and clarity of explanation, and that information and controls may be rearranged or presented differently without departing from the scope of the invention.

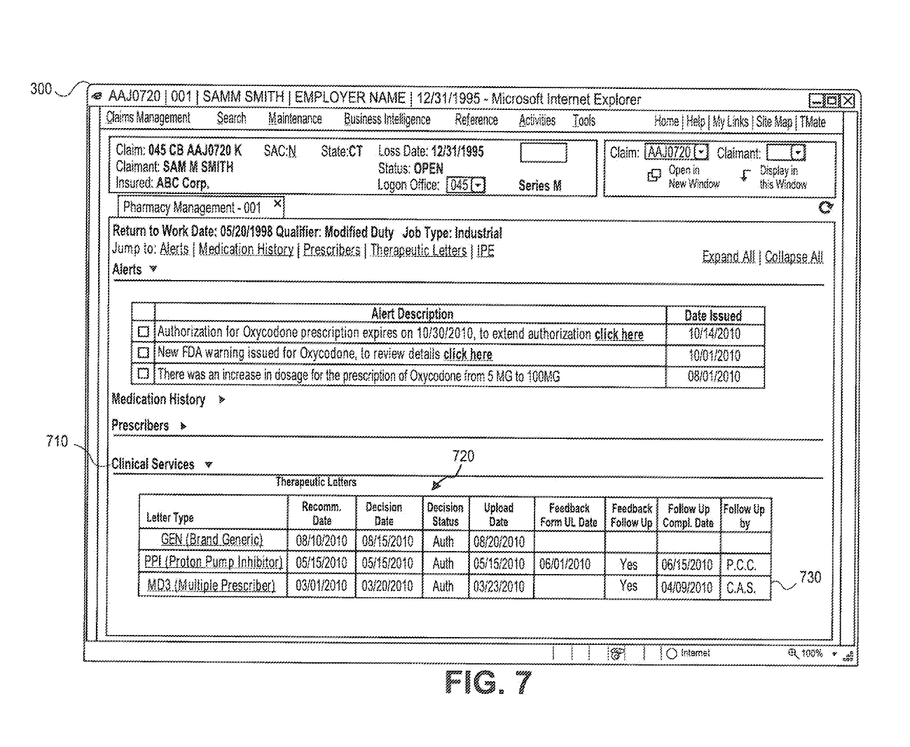

FIG. 7 is a depiction of an exemplary user interface 300 for presenting therapeutic letter information, consistent with embodiments of the invention. The embodiment shown in FIG. 7 depicts yet another pharmacy management screen configuration of user interface 300, with the “Clinical Services” section 710 selected for display and populated with therapeutic alert letter data. In various embodiments, a claim professional will access the pharmacy management screen of FIG. 7 via a control, link, or task in another application (such a medical claim management application), via a control, link, or task in another screen of the pharmacy claim management system 150, (such as the dashboard screen of FIG. 3), or via a control, link or task that is part of a notification to the claim professional, such as an email or instant message related to a request for authorization from a pharmacy, or the like.

In various embodiments, clinical services section 710 of the pharmacy management screen generally will list all completed and in progress clinical services activities associated with the insurance claim identified in section 410. In the example shown, the therapeutic alert letters associated with the claim are presented in a therapeutic letter table 720, which provides information regarding the current status of each letter, such as the type of each letter that was sent, the date each letter was recommended to the claim professional, the date the claim professional decided to authorized or deny the letter, the decision, the date the letter was uploaded to the system (e.g., the date it was mailed to a prescriber), and various other milestones as shown in the columns of therapeutic letter table 720.

As explained above, therapeutic alert letters generally do not require claim professional authorization before being sent out. Various embodiments may employ any number of different types of therapeutic alert letters, and the types may evolve continually. As shown in the example of FIG. 7, one exemplary type of therapeutic alert letters is a “brand generic” letter, which may be used to alert a doctor who is prescribing a brand name drug that a generic alternative is available, and request that the doctor prescribe the generic instead.

In various embodiments, various entries in therapeutic letter table 720 may include controls or links that enables a user to display detailed information, such as the actual letter or feedback form that was send or received/uploaded on the indicated date. In some embodiments, when a feedback form is entered or uploaded into the system, a task may be assigned to the appropriate claim professional, (e.g., as shown by increasing the count associated with clinical services task 340 of FIG. 3) requiring the claim professional to look at the feedback form and follow up with the doctor, if that is desirable. For example, a claim professional may place a follow up call to a doctor to determine why they do not prescribe an available generic, if the feedback form (or lack thereof) indicates that doctor will continue to prescribe a brand name medication. In various embodiments, pharmacy claim management system 150 provides functionality for a claim professional to enter and store information related to follow up, contacts, and associate the follow up information with therapeutic letter table 720.

Various embodiments of therapeutic letter table 720 may display concisely to a claim professional, such as claim handler 170, not only what therapeutic letters were sent out, but they also act as an interactive scheduling and status-tracking tool with which a claim handler 170 can see on an ongoing basis what letters were; recommended and when, whether or not and when the claim handler had authorized that each letter be sent out, whether or not and when a feedback form was received from a prescriber, whether or not and when a claim handler or medical care manager had followed up on the feedback; etc. Such embodiments allow the claim handler to better manage the pharmacy claim from a single interface 300.

One of ordinary skill will recognize that the pharmacy management screen shown on FIG. 7 is necessarily simplified for conciseness and clarity, of explanation, and that information and controls may be rearranged or presented differently without departing from the scope of the invention.

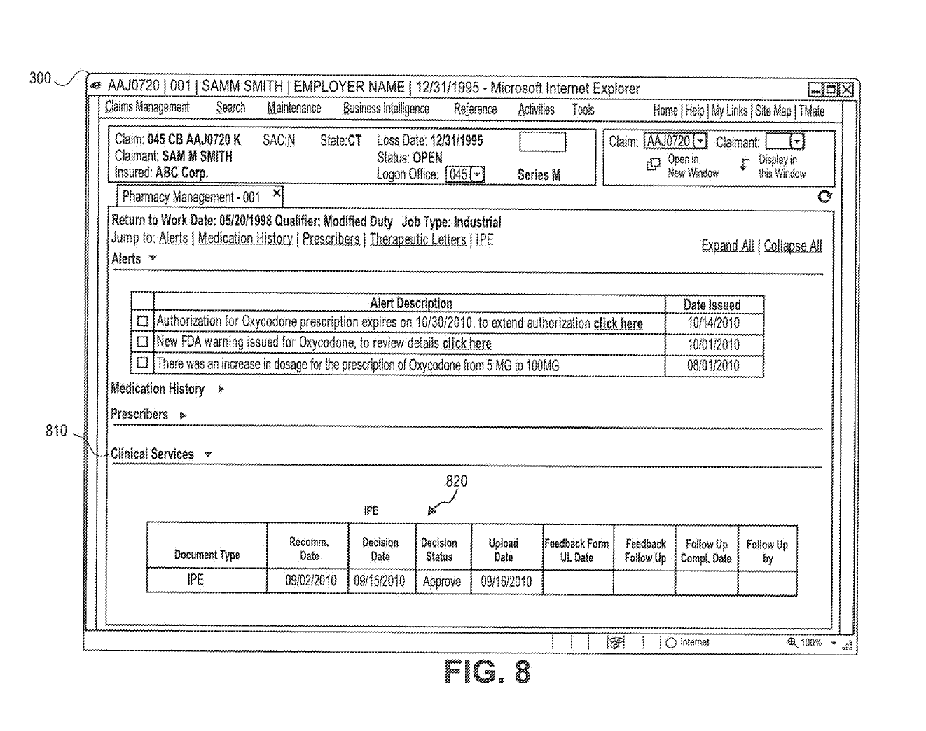

FIG. 8 is a depiction of another exemplary user interface 300 for presenting independent pharmacy evaluation information, consistent with embodiments of the invention. The embodiment shown in FIG. 8 depicts yet another pharmacy management screen configuration of user interface 300, with the “Clinical Services” section 810 selected for display and populated with IPE data. In various embodiments, a claim professional will access the pharmacy management screen of FIG. 8 via a control, link, or task in another application (such a medical claim management application), via a control, link, or task in another screen of the pharmacy claim management system 150, (such as the dashboard screen of FIG. 3), or via a control, link or task that is part of a notification to the claim professional, such as an email or instant message related to a request for authorization from a pharmacy, or the like.

In various embodiments, clinical services section 810 of the pharmacy management screen generally will list all IPE clinical services activities associated with the insurance claim identified in section 410. In the example shown, an IPE associated with the claim is presented in an IPE table 820, which provides information regarding the current status of each IPE, such as the type of each IPE document (e.g., “IPE Report”, “IPE Physician Letter”, or “IPE Miscellaneous”), the date each IPE was recommended to the claim professional, the date the claim professional decided to authorize or deny the IPE, the decision (which may include a control to display the denial reason (if any)), the date the IPE document was, uploaded to the system (e.g., the date it was mailed to a prescriber(s)), and various other milestones as shown in the columns of therapeutic letter table 820.

In various embodiments, an IPE may be recommended for complex claim cases that meet specific criteria, such as those involving multiple medications prescribed by multiple physicians. Implementation of the IPE may involve contacting the physicians involved (e.g., via customized letters) and supplying information regarding what other physicians are prescribing and recommendations for future prescription practices. In the embodiment show, the physicians may respond with follow up forms, letters, etc., which are entered into the system and made accessible to the claim professional, for example via a control or link on the screen shown in FIG. 8.

In various other embodiments, other links and/or controls for accessing and displaying additional IPE-related data may be provided with IPE table 820, such as a link from the date completed which displays the exact IPE document sent to the physician(s); a link from the feedback form, upload (UL) date that displays the received form, notes, or other information from follow up contacts with the physician(s) regarding the findings of the IPE, the dangers of ignoring the recommendations, etc.

Various embodiments of IPE table 820 may display, concisely to a claim professional, such as claim handler 170, not only what IPE document(s) were sent out, but they also act as an interactive scheduling and status-tracking tool with which a claim handler 170 can see on an ongoing basis what IPEs were recommended and when, whether or not and when the claim handler had authorized that each IPE be conducted, whether or not and when a feedback form or other feedback communication was received from a prescriber, whether or not and when a claim handler or medical care manager had followed up on the feedback, etc. Such embodiments allow the claim handler to better manage the pharmacy claim from a single interface 300.

One of ordinary skill will recognize that the pharmacy management screen shown on FIG. 8 is necessarily simplified for conciseness and clarity of explanation, and that information and controls may be rearranged or presented differently without departing from the scope of the invention.

In sum, the exemplary pharmacy claim management displays shown in FIGS. 3-8, and the underlying functionality and data, may quickly and clearly provide a claim professional with well-organized information, knowledge, and history specific to a pharmacy insurance claim, and enables the claim professional to make well-informed, and accurately informed decisions that affect the insurance claim.

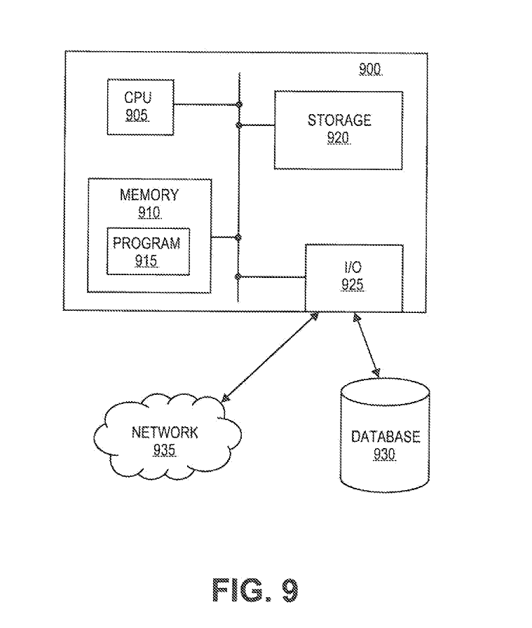

FIG. 9 is a block diagram of an exemplary computing system or data processing system 900 that may be used to implement embodiments consistent with the invention. Other components and/or arrangements may also be used. In some embodiments, computing system 900 may be used to implement a pharmacy claim management system 150.

Computing system 900 includes a number of components, such as a central processing unit (CPU) 905, a memory 910, an input/output (I/O) device(s) 925, and a nonvolatile, storage device 920. System 900 can be implemented in various ways. For example, an implementation as an integrated platform (such as a workstation, server, personal computer, laptop, smart phone, etc.) may comprise CPU 905, memory 910, nonvolatile storage 920, and I/O devices 925. In such a configuration, components 905, 910, 920, and 925 may connect and communicate through a local data bus and may access a database 930 (implemented, for example, as a separate database system) via an external I/O connection. I/O component(s) 925 may connect to external devices through a direct communication link (e.g., a hardwired or local Wi-Fi™ connection), through a network, such as a local area network (LAN) or a wide area network (WAN), and/or through other suitable connections. System 900 may be standalone or it may be a subsystem of a larger system.

CPU 905 may be one or more known processing devices, such as a microprocessor from the Core™ 2 family manufactured by the Intel™ Corporation of Santa Clara, Calif. Memory 910 may be one or more fast storage devices configured to store instructions and information used by CPU 905 to perform certain functions, methods, and processes related to embodiments of the present invention. Storage 920 may be a volatile or non-volatile, magnetic, semiconductor, tape, optical, or other type of storage device or computer-readable storage medium, including devices such as CDs and DVDs, meant for long-term storage.

In the illustrated embodiment, memory 910 contains one or more programs or subprograms 915 loaded from storage 920 or from a remote system (not shown) that, when executed by CPU 905, perform various operations, procedures, processes, or methods consistent with the present invention. Alternatively, CPU 905 may execute one or more programs located remotely from system 900. For example, system 900 may access one or more remote programs via network 935 that, when executed, perform functions and processes related to or implementing embodiments of the present invention.

In one embodiment, memory 910 may include a program(s) 915 that implements a pharmacy claim management system, including flowchart 200 and user interface displays as shown in FIGS. 3-8 and/or a program 915 that implements a pharmacy benefit management system 140. In some embodiments, memory 910 may also include other programs or applications that implement other methods and processes that provide ancillary functionality to the invention. For example, memory 910 may include programs that gather from various sources, organize, store, and/or generate claim data used by pharmacy claim management system 150, and programs that communicate with other systems, such as pharmacy benefit management system 140.

Memory 910 may be also be configured with other programs (not shown) unrelated to the invention and/or an operating system (not shown) that performs several functions well known in the art when executed by CPU 905. By way of example, the operating system may be Microsoft Windows™, Unix™, Linux™, an Apple Computers™ operating system, Personal Digital Assistant operating system such as Microsoft CE™, or other operating system. The choice of operating system, and even to the use of an operating system, is not critical to the invention.

I/O device(s) 925 may comprise one or more input/output devices that allow data to be received and/or transmitted by system 900. For example, I/O device 925 may include one or more input devices, such as a keyboard, touch screen, mouse, and the like, that enable data to be input from an administrative user, such as a system operator. Further, I/O device 925 may include one or more output devices, such as a display screen, CRT monitor, LCD monitor, plasma display, printer, speaker devices, and the like, that enable data to be output or presented to a user, such as a claim handler 170. I/O device 925 may also include one or more digital and/or analog communication input/output devices that allow computing system 900 to communicate, for example, digitally, with other machines and devices. Other configurations and/or numbers of input and/or output devices may be incorporated in I/O device 925.

In the embodiment shown, system 900 is connected to a network 935 (such as the Internet, a private network, a virtual private network, or other network), which may in turn be connected to various systems (e.g., pharmacy benefit management system 140) and computing machines (not shown), such as personal computers, laptop computers, and/or smart phones of claim handlers 170 who wish to utilize pharmacy claim management system 150. In general, system 900 may input data from external machines and devices and output data to external machines and devices via network 935.

In the exemplary embodiment shown in FIG. 9, database 930 is a standalone database external to system 900. In other embodiments, database 930 may be hosted by system 900. In various embodiments, database 930 may manage and store data used to, implement systems and methods consistent with the invention. For example, database 930 may manage and store data structures that contain claim end claimant data used to populate pharmacy claim management displays, such as those illustrated in FIGS. 3-8.

Database 930 may comprise one or more databases that store information and are accessed and/or managed through system 900. By way of, example, database 930 may be an Oracle™ database, a Sybase™ database, or other relational database. Systems and methods consistent with the invention, however, are not limited to separate data structures or databases, or even to the use of a database or data structure.

It will be apparent to those skilled in the art that various modifications and variations can be made to the structures and methodologies described herein. Thus, it should be understood that the invention is not limited to the examples discussed in the specification. Rather, the present invention is intended to cover modifications and variations.

What is claimed is:

1. A method, implemented using a computing system, for managing pharmacy insurance claims, the method comprising:
receiving a request to authorize an action associated with a pharmacy claim, wherein the request includes information identifying the pharmacy claim;
accessing, using the computing system, data corresponding to the pharmacy claim;
presenting to a user, using the computing system, the data corresponding to the pharmacy claim; and
enabling the user, using the computing system, to respond to the request to authorize the action.

2. The method of claim 1, wherein the request to authorize an action associated with the pharmacy claim comprises a request for a prior authorization approval to fill a prescription under the pharmacy claim.

3. The method of claim 1, wherein the request to authorize an action associated with the pharmacy claim comprises a request to authorize payment of a pharmacy bill under the pharmacy claim.

4. The method of claim 1, wherein the request to authorize an action associated with the pharmacy claim comprises a request to authorize a pharmacy evaluation service associated with the pharmacy claim.

5. The method of claim 1, wherein the request to authorize an action associated with the pharmacy claim comprises a request to authorize a home delivery.

6. The method of claim 1, wherein presenting the data corresponding to the pharmacy claim comprises:
presenting the data on a graphical user interface that allows the user to display the data on a single screen.

7. The method of claim 1, wherein enabling the user to respond comprises:
placing the user in an external application program that accepts a response from the user.

8. The method of claim 7, further comprising:
receiving data confirming the response from the external application program; and
updating the data corresponding to the pharmacy claim to reflect the data confirming the response.

9. A system for managing pharmacy insurance claims comprising:
a memory containing instructions; and
a processor; operably connected to the memory, that executes the instructions to perform operations comprising:
receiving a request to authorize an action associated with a pharmacy claim, wherein the request includes information identifying the pharmacy claim;
accessing data corresponding to the pharmacy claim;
presenting to a user the data corresponding to the pharmacy claim; and
enabling the user to respond to the request to authorize the action.

10. The system of claim 9, wherein the request to authorize an action associated with the pharmacy claim comprises a request for a prior authorization approval to fill a prescription under the pharmacy claim.

11. The system of claim 9, wherein the request to authorize an action associated with the pharmacy claim comprises a request to authorize payment of a pharmacy bill under the pharmacy claim.

12. The system of claim 9, wherein the request to authorize an action associated with the pharmacy claim comprises a request to authorize a pharmacy evaluation service associated with the pharmacy claim.

13. The system of claim 9, wherein the request to authorize an action associated with the pharmacy claim comprises a request to authorize a home delivery.

14. The system of claim 9, wherein presenting the data corresponding to the pharmacy claim comprises:
presenting the data on a graphical user interface that allows the user to display the data on a single screen.

15. The system of claim 9, wherein enabling the user to respond comprises:
placing the user in an external application program that accepts a response from the user.

16. The system of claim 15, wherein the operations further comprise:
receiving data confirming the response from the external application program; and
updating the data corresponding to the pharmacy claim to reflect the data confirming the response.

17. A method, implemented using a computing system, for facilitating pharmacy insurance claims, the method comprising:
receiving, from a user, using the computer system, a request for an action, wherein the request is responsive to an electronic notification associated with a pharmacy claim;
opening a user interface in response to the request from the user;
displaying, in a first portion of the user interface, information identifying the pharmacy claim;
displaying, in a second portion of the user interface, information indicating a work status of a claimant for the pharmacy claim;
displaying, in a third portion of the user interface, a medication history for the pharmacy claim.

18. The method of claim 17, wherein displaying the medication history comprises:
displaying an indication of whether a prescription bill for a medication was approved for coverage or denied.

19. The method of claim 17, further comprising:
displaying, in a fourth portion of the user interface, a list of prescribers for the pharmacy claim;
wherein the fourth portion of the user interface may be co-located with the third portion of the user interface.

20. The method of claim 19, wherein displaying the list of prescribers comprises:
displaying an indication of whether each prescriber in the list was authorized or not authorized to prescribe medication under, the pharmacy claim.

21. The method of claim 17, further comprising:
displaying, in a fourth portion of the user interface, a list of alert messages that are relevant to the pharmacy claim;
wherein the fourth portion of the user interface may be co-located with the third portion of the user interface.

22. The method of claim 17, further comprising:
displaying, in a fourth portion of the user interface, a list of clinical services associated with the pharmacy claim;
wherein the fourth portion of the user interface may be co-located with the third portion of the user interface.

23. The method of claim 17, further comprising:
providing, to the user, the electronic notification associated with the pharmacy claim.

24. The method of claim 17, wherein the electronic notification relates to a request to authorize an action associated with the pharmacy claim.

25. The method of claim 24, wherein the request to authorize an action associated with the pharmacy claim comprises a request for a prior authorization approval to fill a prescription under the pharmacy claim.

26. The method of claim 24, wherein the request to authorize an action associated with the pharmacy claim comprises a request to authorize payment of a pharmacy bill under the pharmacy claim.

27. The method of claim 24, wherein the request to authorize an action associated with the pharmacy claim comprises a request to authorize a pharmacy evaluation service associated with the pharmacy claim.

28. The method of claim 24, wherein the request to authorize an action associated with the pharmacy claim comprises a request to authorize a home delivery.
